(19) United States
(12) Patent Application Publication
(10) Pub. No.: US 2019/0023163 A1
(43) Pub. Date: Jan. 24, 2019

(54) SEAT COVER MADE OF LEATHER FOR A VEHICLE SEAT

(71) Applicant: GST Acquisition Corp., Southfield, MI (US)

(72) Inventor: Florian M. Schrey, Dusseldorf (DE)

(21) Appl. No.: 16/081,589

(22) PCT Filed: Mar. 3, 2017
(86) PCT No.: PCT/EP2017/000288

§ 371 Date: Aug. 31, 2018

(30) Foreign Application Priority Data
Mar. 4, 2016 (DE) 10 2016 002 587.5

(51) Int. Cl. B60N 2/60; B60N 2/58

(52) U.S. Cl. CPC B60N 2/6036; B60N 2/6045; B60N 2/6081; B60N 2/609; B60N 2/5833; B60N 2/5841; B60N 2/5875; B60N 2/5883; B60N 2/5891

(57) ABSTRACT

A seat cover made of leather for a vehicle seat is disclosed. The seat cover has two or more blank parts as first blank parts, wherein the first blank parts are joined to each other on at least one joining edge. At least one first blank part has a width that is at least equal to the width of a following blank part of a follower and the first blank part has a length that is at least equal to the length of the following blank part of the follower.

### CROSS-REFERENCE TO RELATED APPLICATIONS

This application is a national phase application under 35 U.S.C. § 371 of International Patent Application Serial No. PCT/EP2017/000288, filed Mar. 3, 2017, entitled “SEAT COVER MADE OF LEATHER FOR A VEHICLE SEAT,” which claims priority to and the benefit of German Patent Application Serial No. 10 2016 002 587.5, filed Mar. 4, 2016, both of which are hereby incorporated by reference in their entireties.

### TECHNICAL FIELD

The disclosure relates to a seat cover made of leather for a vehicle seat, which has one or more panels functioning as initial panels, wherein the initial panels are joined along at least one seam.

### BACKGROUND

The leather typically used for seat covers in vehicles is of a high quality regarding the durability and lifespan thereof, such that the leather can be used for subsequent products such as shoes, handbags or other fashion accessories after it has been used as a leather seat cover. Currently, however, leather seat covers for vehicles are normally produced such that a subsequent recycling of the leather is difficult because the leather seat cover is permanently fastened to the vehicle seat, the seams are difficult to undo, or the surface of the leather facing the vehicle is coated. Because of the processing of the leather seat cover, the leather is normally discarded or destroyed these days, even though the leather of vehicle seats in particular is a valuable commodity.

A foam material is known from DE 10 2012 217 969 A1. It is used in the production of automobile seats, and after discarding the automobile seat, it is then used as a sound absorbing building material. This idea inspired the recycling of raw materials in constructing vehicle seats, although the recycling of seat covers is not addressed in this document.

Recycling of the leather material in vehicle seat covers saves valuable raw materials and contributes to environmental conservation. In particular, by using recycled leather, the technically complex and expensive tanning process for animal skins is no longer necessary.

### SUMMARY

The object of the disclosure is therefore to create a seat cover made of leather for vehicle seats, with which the panels composing the seat cover can be separated easily, inexpensively, and without a great deal of technology, into sizes and qualities that can subsequently be joined to one another to form subsequent products.

The object is achieved according to the disclosure with a seat cover that has the features of claim 1, wherein the seat cover has at least one initial panel that is at least as wide as a subsequent panel, and the initial panel is at least as long as the subsequent panel of the subsequent product.

By making an initial panel this size, it is ensured that the initial panel is at least as large as a subsequent panel in a subsequent product. This has the advantage that a subsequent panel can be cut or removed from an initial panel, such that it can subsequently be joined to a subsequent product and thus be recycled.

A further aspect of the disclosure provides that at least one initial panel of the seat cover is the same size and shape as a subsequent panel of a subsequent product. This should be understood to mean that the initial panel is already in the shape of a subsequent panel, wherein an excess or margin may be provided on the edge, in particular, which may be necessary for producing the subsequent product.

Because at least one initial panel is the same size and shape of a subsequent panel, the initial panel is immediately available for producing a subsequent product after it has been removed from the seat cover.

Advantageously, this design of an initial panel results in there being no need for further processing of the initial panel after removing it from the seat cover in order to use is for a subsequent product, such the recycling process of the leather of the seat cover is reduced by at least one step, thus resulting in a more efficient recycling of the leather.

It is provided in another embodiment of the disclosure that at least one initial panel is the same thickness as a subsequent panel of a subsequent product.

In this manner, the initial panel can be used as a subsequent panel after removal from the seat cover, without having to alter the thickness of the leather. As a result, when recycling the leather of the seat cover, the thickness of the leather layer advantageously does not have to be modified, such that a production step is eliminated in the processing to form a subsequent product, thus speeding up and simplifying the production of the subsequent product from the seat cover.

A further recycling-friendly variation of the disclosure provides that at least one initial panel has the same surface structure on the side facing away from the vehicle seat as the front surface of a subsequent panel of a subsequent product.

With an initial panel that has the same surface structure as the surface of a subsequent panel it is no longer necessary to further process the surface of the leather in a further processing step when the seat cover is recycled. As a result, a production step is eliminated in the production of the subsequent product, thus enabling a more efficient recycling of the leather.

A further embodiment of the seat cover according to the disclosure is characterized in that at least one initial panel has the same surface structure on the side facing toward the vehicle seat as the back surface of a subsequent panel of a subsequent product.

This selection of the surface structure of the initial panel also eliminates an additional surface processing for producing a subsequent product, such that the leather in a seat cover can be recycled more quickly and with less difficulty.

In a further variation of the disclosure, it is provided that at least one initial panel has at least one backing layer on the side of the leather facing toward the vehicle seat, at least in sections. In particular, the backing layer is selected such that this backing layer can be used as the back layer of a subsequent panel of a subsequent product.

In this manner, a backing layer can already be applied to the initial panel of a seat cover during production thereof, which is to be used as a layer of the subsequent product after the seat cover is removed and separated into subsequent panels. As a result, a coating step is advantageously eliminated in the production of the subsequent product, thus simplifying the recycling of the leather.

A particularly practical embodiment of the disclosure can provide that the backing layer is a mesh, knit fabric, nonwoven, plastic foam, or batting. In particular, a textile backing layer is preferred thereby.

With this type of backing layer, an inner layer may be provided for the subsequent product that fulfills a specific function. By way of example, the use of a textile backing layer can improve the surface tension and durability of the leather material, wherein the feel, durability and/or stability of the subsequent product, e.g. a shoe, is improved through the use of a textile backing layer. Advantageously, a production step is consequently eliminated in the production of the subsequent product, increasing the efficiency of the recycling of the leather.

A further variation of the disclosure provides that the backing layer is bonded to the leather, wherein an adhesive fabric, a powdered adhesive, a liquid adhesive, a two-component adhesive, or a self-adhesive film are preferred for the bonding material. In particular, a self-adhesive film is provided for a recycling-friendly solution to the problem.

The use of a backing layer that can be easily removed offers the possibility of easily removing the backing layer from the leather when separating the seat cover into the initial panels, thus exposing the leather for recycling processes. A self-adhesive film, for example, which can be removed from the leather mechanically, is ideal for this. As a result, backing layers, typically applied to leather to maintain the form of the seat cover, can be easily detached and removed from the leather. Consequently, the leather can be advantageously exposed in a simple manner, and can thus be used for producing a subsequent product that does not have a backing layer.

A further embodiment of the disclosure is characterized in that at least one initial panel of the seat cover, which is the same shape and size as a subsequent panel of a subsequent product, has a different surface structure and/or backing layer on the surface facing toward the vehicle seat than at least one further initial panel of the seat cover.

By selecting the surface of an initial panel that is the same size and shape of a subsequent panel in this manner, it is ensured that this initial panel can be used directly as a subsequent panel after removing it from the seat cover, without the need for further production steps. In particular, the corresponding initial panel may have another surface structure on the surface facing the vehicle seat, which is not visible when used as a vehicle seat, but may be beneficial when used in the subsequent product. By way of example, the initial panel may have a woven backing layer that forms a cushion in a shoe. As a result, it is already advantageously possible to anticipate the use as a subsequent panel during the production of the initial panel, thus increasing the efficiency of the recycling process. In particular, neither a surface processing, nor a tailoring to the subsequent product is needed with this variation after breaking down the seat cover, such that this panel can be used directly in the subsequent product.

Another recycling-friendly embodiment of the disclosure is characterized in that no more than 50% of the surface of an initial panel is provided with a backing layer.

The limited and local use of a backing layer enables, firstly, that the mechanical properties of the seat cover, such as the tension and durability, are preserved, and secondly, enough uncoated leather is provided that can subsequently be used for recycling. Advantageously, at least 50% of the leather surface can be used for producing a subsequent panel without removing a backing layer, such that a portion of the leather of the seat cover is also available for a subsequent product, without removing the backing layer.

In a particularly recycling friendly variation of the disclosure, it is provided that at least one initial panel has no backing layer in a recycling section that is at least the same length and width as a subsequent panel. The recycling section is preferably located in the central region of an initial panel, because the mechanical load is typically greater in the region of the joining edge, and an additional backing layer for improving the durability of the seat cover is advantageous there.

By providing a recycling section that is at least as long and wide as a subsequent panel, it is ensured that this region of the initial panel can be used as a subsequent panel, without having to mechanically or chemically remove a backing layer. The provision of recycling sections has the advantage that in producing a subsequent panel in which only the leather is desired, it is not necessary to remove a backing layer, thus making the recycling process significantly more efficient.

A variation of the disclosure preferred for recycling is characterized in that at least one initial panel is joined to at least one further initial panel at at least one fastening edge with a joining technology that can be readily separated.

The use of a joining technology that can be easily separated enables a separation of the initial panels without a great deal of technological effort. This has the advantage that the initial panels can be easily recycled to form subsequent panels.

A particularly practical embodiment of the disclosure provides that at least one initial panel is joined at an edge to at least one further initial panel by means of ultrasonic welding and/or by means of self-dissolving thread.

The use of ultrasonic welding and/or self-dissolving threads for the joining technology enables a simple separation of the initial panels of the seat cover from one another. In particular, self-dissolving threads, which dissolve when subjected to electromagnetic radiation, chemical substances or heat, enable a simple separation. Use of these joining technologies has the advantage that the separation of the initial panels can be carried out particularly quickly and without mechanical loads to the leather. As a result, the recycling is simplified, and the waste in terms of the loss of leather damaged during the separation of the seat cover is reduced.

A further embodiment of the disclosure is characterized in that at least one initial panel has a fastening edge on the surface facing toward the vehicle seat, on which at least one fastening element is located. The seat cover is attached and secured to the vehicle seat with the fastening elements.

Because the fastening element is located in the edge region of the initial panel, the central region of the initial panel does not have this fastening element, and is thus available for recycling. This advantageously makes the largest possible cohesive surface of the initial panel available for recycling.

In a further embodiment of the disclosure, it is provided that the fastening element is a mechanical element, a Velcro fastener, an adhesive surface, or a clasp.

By using such fastening elements, detaching the seat cover from the automobile seat is particularly simple, such that it can then be advantageously separated in a separating step without a great deal of effort. In particular, this embodiment of the disclosure should prevent the need to bond the seat cover to the vehicle seat with adhesives, in order to avoid a complicated mechanical or chemical removal of the seat cover form the vehicle seat, and thus make the recycling of the leather more efficient.

In a further embodiment of the disclosure, the fastening element is joined to the surface of the initial panel facing toward the vehicle by means of a detachable joining technology. In particular, the fastening element is joined by means of ultrasonic welding, or a detachable force-fit and/or detachable adhesive technology.

Such a joining of the fastening element to an initial panel makes it possible to easily remove the fastening elements from the seat cover. This has the advantage that it is easy to separate the initial panels of the seat cover, and the fastening elements can likewise also be easily removed. As a result, the seat cover can be separated into its individual components quickly and easily, such that the initial panels can be used without difficulty for subsequent panels. This reduces the mechanical and technological effort for recycling the seat cover.

It is provided in the disclosure that the subsequent product is preferably a shoe, handbag, suitcase, wallet, furniture and/or at least part of an article of clothing that has at least one subsequent panel.

The leather materials that are typically used in vehicle seats can be recycled to form the listed subsequent products. It is advantageous thereby that the leather in vehicle seats is distinguished by its high durability and surface quality, which can be recycled to produce high-quality subsequent products.

A method for producing a seat cover made of leather, and subsequent panels of a subsequent product is provided according to the disclosure, comprising an initial tailoring step, a seat cover joining step, a separating step, and a subsequent tailoring step. The initial tailoring results in an initial panel that is at least the same width as a subsequent panel of a subsequent product, and is at least the same length as the subsequent panel of the subsequent product, and the initial panels are joined in the joining step to form a seat cover, and then the seat cover is separated into the initial panels in the separating step, and in the subsequent tailoring step, at least one subsequent panel is cut out of the at least one initial panel, which can be used for producing a subsequent product.

A seat cover is produced with this method, from which the subsequent panels of a subsequent product are made available for recycling. The method offers the advantage that the leather used for producing the seat cover can be easily used later for the subsequent panel of a subsequent product, and thus be recycled. As a result, certain production steps can be eliminated in the production of leather goods, and valuable resources can be preserved. In particular, a complicated, often ecologically dangerous and expensive tanning of animal skins is avoided through the recycling of leather seat covers.

A further method for producing a seat cover made of leather, and subsequent panels of a subsequent product composed thereof, is characterized in that the method comprises an initial tailoring step in which at least one initial panel is the same size and shape as a subsequent panel of a subsequent product, a seat cover joining step in which the initial panels are joined to form a seat cover, and a separating step in which the seat cover is separated into the initial panels, wherein at least one initial panel can be used as a subsequent panel for producing a subsequent product.

Because at least one initial panel is the same size and shape as a subsequent panel of the subsequent product, a subsequent tailoring can be eliminated in the production of the subsequent panel. The subsequent panel to be used for producing the subsequent product is thus available immediately after the separating step, such that a production step can be eliminated in the production of the subsequent product. This has the advantage that the recycling of the leather can be carried out more easily, and with fewer production steps.

### BRIEF DESCRIPTION OF THE DRAWINGS

The features of the present disclosure shall be described in detail below with reference to exemplary embodiments thereof, which are illustrated in the attached drawings. Therein:

FIG. 1 shows a seat cover according to the disclosure,

FIG. 2 shows a side view of an initial panel,

FIG. 3 shows the top view of an initial panel,

FIG. 4a shows two initial panels joined at the joining edge with a fastening element,

FIG. 4b shows two initial panels joined at the joining edge with a fastening element,

FIG. 5 shows a flow chart for a method for producing a seat cover and subsequent panels of a subsequent product composed thereof, and

FIG. 6 shows the sequence of a method for producing a seat cover and subsequent panels of a subsequent product composed thereof, wherein an initial panel is the same size and shape of a subsequent panel.

### DETAILED DESCRIPTION

The following description is merely exemplary in nature and is not intended to limit the disclosure in its application or uses. For purposes of clarity, the same reference numbers are used in the description and drawings to identify similar elements.

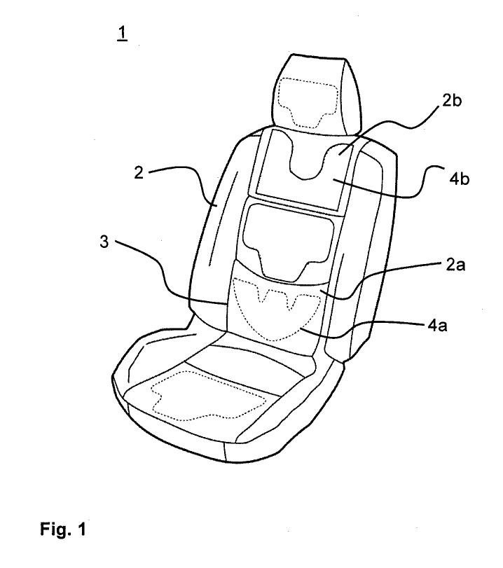

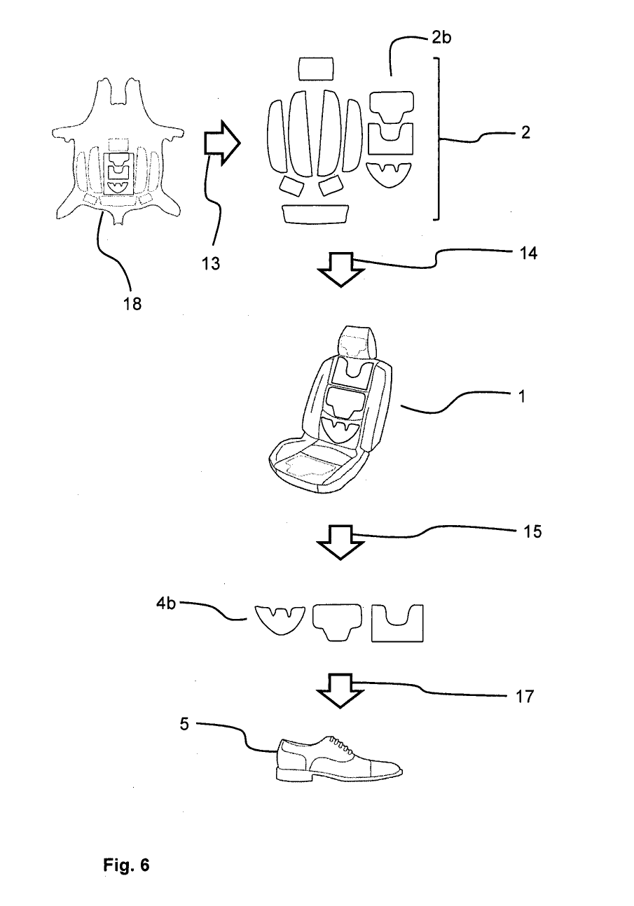

The seat cover 1 according to the disclosure is schematically illustrated in FIG. 1, wherein this seat cover is composed of numerous initial panels 2, which are joined at the edges 3. At least one of the initial panels 2a is at least the same width as a subsequent panel 4a. Furthermore, this initial panel 2a is at least as long as a subsequent panel 4a. The subsequent panel 4a is depicted in FIG. 1 by a broken line, which indicates a cutting line in a separating step 15 for the initial panel 2. The unbroken thin lines, on the other hand, indicate joining edges 3, at which the initial panels 2 are joined to one another. The size of at least one initial panel 2a is selected such that a subsequent panel 4a can be cut from it, from which a subsequent product 5 can be produced by the methods depicted in FIG. 5 and FIG. 6 for recycling purposes. Such a selection of the size of the initial panel enables a recycling of the leather, and thus a savings in terms of valuable resources.

As is also shown in FIG. 1, an initial panel 2b can be the same size and shape as a subsequent panel 4b in one embodiment variation of the disclosure. In this embodiment variation, there is at least one subsequent panel 5b available after the separating step 15 in which the seat cover 1 is separated at the joining edges 3 into the initial panels 2, which can be used without further tailoring for assembling a subsequent product 5. It is preferred in this embodiment variation that the production method shown in FIG. 6 is used. The use of initial panels 2 that are the same size and shape as a subsequent panel 4b offers the advantage with the recycling of the leather of a seat cover 1 that a further subsequent tailoring step 16 is eliminated in the production of a subsequent product 5. It is thus possible to obtain a more efficient recycling of the frequently valuable leather in seat covers.

In one embodiment variation, which is not explicitly depicted in the figures, at least one initial panel 2 is the same thickness as the subsequent panels 4a and 4b of the subsequent product 5. When the thickness of an initial panel 2 is selected in this manner in the recycling thereof to form a subsequent product 5, an adjustment of the thickness is unnecessary, and a production step can thus be eliminated. For a better recycling of a subsequent panel 4, it is also advantageous when at least one initial panel 2 has the same surface structure on the side facing the vehicle seat as the front surface of a subsequent panel 4 for the subsequent product 5. As a result, a front surface treatment is eliminated in the production of the subsequent product 5, such that a more efficient recycling of the leather can be implemented. A further embodiment of the disclosure, not shown, provides that at least one initial panel 2 has the same surface structure on the side facing the vehicle seat as the back surface of a subsequent panel 4 of a subsequent product 5. In this manner, the surface facing the vehicle seat can already be designed such that it can be used for producing the subsequent product 5 without further processing.

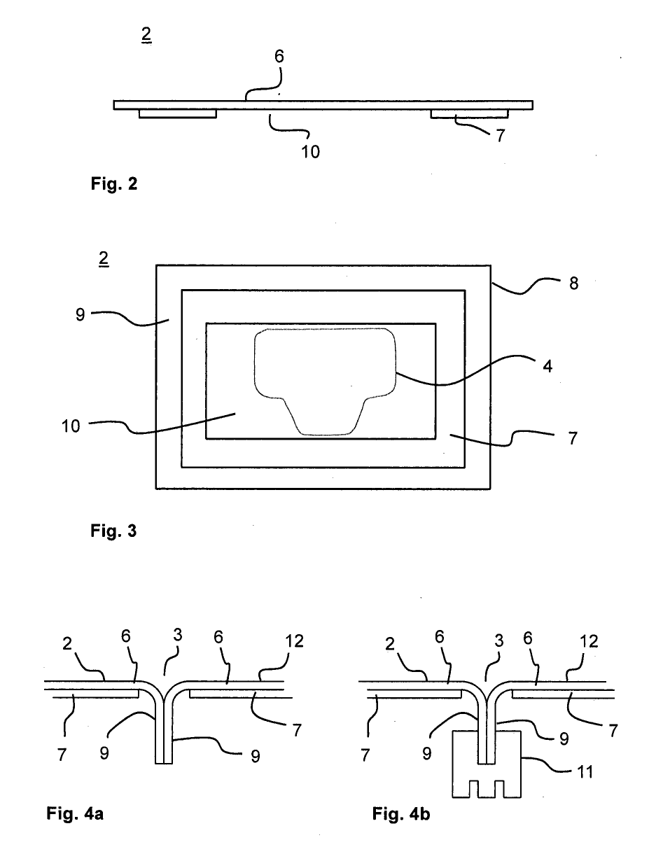

As shown in FIG. 2, one embodiment of the disclosure provides that the initial panel 2 has a backing layer 7, at least in sections, on the side of the leather 6 facing toward the vehicle seat. The leather 6 of a seat cover 1 is typically provided with a backing layer 7, in order to improve the mechanical properties of the leather 6, and to prevent, for example, a wrinkling of the leather 6, or to increase the durability thereof. The backing layer 7 is typically formed by a mesh, knit fabric, nonwoven, plastic foam, or batting. This type of backing layer 7 can be used as the back surface of the subsequent panel 4 in the production of a subsequent product 5. By way of example, the use of a textile backing layer 7 results in the back surface of a subsequent panel 4 of a subsequent 5 having a better feel, an insulating effect, and/or a better mechanical durability.

In one embodiment of the disclosure, the backing layer 7 is bonded to the leather 6 in a material bonded manner, wherein this bond can be easily separated. The bonding materials are preferably composed of an adhesive fabric, powdered adhesive, liquid adhesive, two-component adhesive, or a self-adhesive film. Self-adhesive films are preferably used, because these can be easily removed. A readily detached bond between the leather 6 and the backing layer 7 offers the advantage that the backing layer 7 can be easily removed when recycling the leather 6 of the seat cover 1. This is particularly advantageous when the backing layer 7 is not desired in the subsequent product 5.

Taking into account the fact that the backing layer 7 may be unnecessary, or even unbeneficial in many of the subsequent products 6, one embodiment variation, not shown, provides that no more than 50% of the surface of an initial panel 2 is provided with a backing layer 7. In this manner, it is ensured that at least 50% of the surface of an initial panel 2 has no backing layer 7, and can thus be used in a subsequent product 5 without further surface treatment. In this variation, only the parts of the initial panel 2 that absolutely require a backing layer 7 are provided with a backing layer in the production of the seat cover 1, in order to ensure certain mechanical properties such as durability, elasticity and/or adhesion of the seat cover 1.

An embodiment of an initial panel 2 is shown in a top view in FIG. 3, looking at the surface facing toward the vehicle seat, wherein the initial panel 2 has an outer edge 8. The initial panel 2 has a recycling section 10 that is at least as long and wide as a subsequent panel 4. The recycling section 10 is provided with a smaller backing layer 7, such that the leather 6 can be used directly for the subsequent product 5 after the subsequent panel 4 has been cut out. By providing a recycling section 10, there is the advantage that a further treatment of the surface of the subsequent panel 4 facing toward the vehicle seat is unnecessary, and the recycling process is more efficient.

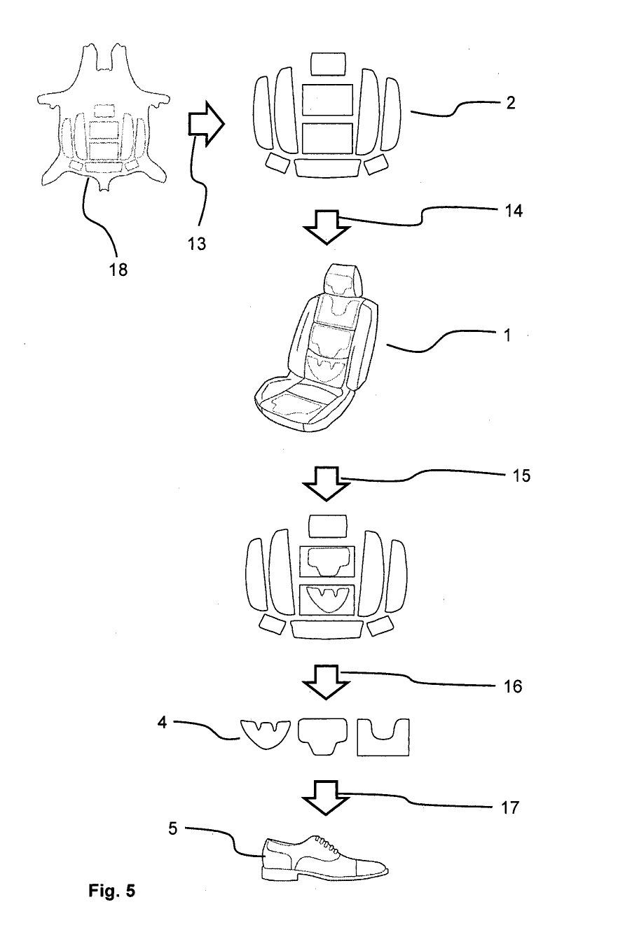

FIG. 4a schematically shows the joining of one initial panel 2 to a further initial panel 12 at the joining edge 3. The initial panels 2 and 12 are joined in the region of the fastening edge 9 by means of a joining technology that can be easily separated, such that the seat cover 1 can be easily separated into the initial panels 2 in a separating step 15. Either ultrasonic welding or a self-dissolving thread are preferably used for the joining. These joining technologies are distinguished in that they can be separated with comparatively little technological effort, without significantly compromising or destroying the leather material. By way of example, self-dissolving thread can be dissolved by applying chemicals, electromagnetic radiation or heat, such that a mechanical load to the leather is eliminated in the separating step 15. Advantageously, the leather of the initial panel 2 is subjected to a minimal load, such that the largest possible area of good quality can be used for recycling. The fastening edge 9 preferably has no coating 7, in order to reduce the thickness of the leather 6 as much as possible when folded over to form a hem.

The initial panel 2 has a fastening edge 9, as shown in FIG. 3, on which at least one fastening element 11, as shown in FIG. 4, can be located. The fastening element 11 is provided for fastening the seat cover 1 to an automobile seat. Because the fastening element 11 is located at the fastening edge 9, only the edge region of the initial panel 2 is provided with fastening elements 11, such that the largest possible area is available for recycling the leather in the central region of the initial panel 2. The fastening element 11 is preferably a mechanical element, e.g. a Velcro fastener, an adhesive surface, or a clasp, such that the seat cover 1 can be removed as easily as possible from an automobile seat. A recycling of the leather is therefore simplified in this respect, in that the seat cover 1 can be removed as quickly as possible, with no major technological effort, and then conveyed to the subsequent procedures.

As shown in FIG. 4b, the fastening element 11 is on the side of an initial panel 2 facing toward the vehicle seat, and is joined to the initial panel 2 with a detachable joining technology. Ultrasonic welding, a detachable force-fit clamping connection, and/or a detachable adhesive technology are preferably used as the joining technology. This offers the advantage that the fastening element 11 can be removed simply when separating the seat cover 1 into the initial panels 2. There is preferably no coating 7 on the leather 6 at the fastening edge 9, in order to reduce the thickness of the leather 6 as much as possible when it has been folded over to form a hem.

The method for producing a seat cover 1 and the resulting subsequent panels 4 of a subsequent product 5 is schematically illustrated in FIG. 5. The initial panels 2 are cut to size from a leather stock 18 in an initial tailoring step 13. At least one of the initial panels 2 is at least as wide as a subsequent panel 4 of a subsequent product 5. It is also at least as long as the subsequent panel 4 of the subsequent product 5. As a result, it is ensured that at least one subsequent panel 4 can be cut out of an initial panel 2. After the initial tailoring 13, the initial panels 2 are assembled to form a seat cover 1 in a seat cover assembly step 14. After use as a seat cover 1, it is separated into the initial panels 2 in a separating step 15, wherein the use of the aforementioned detachable joining technologies simplifies separation. In a subsequent tailoring step 16, at least one subsequent panel 4 is cut from at least one initial panel 2, and the subsequent panels 4 are subsequently assembled in a subsequent assembly step 17 to form a subsequent product 5. The subsequent product 5 can be, e.g. a shoe, handbag, suitcase, wallet, furniture and/or part of an article of clothing. The method schematically shown in FIG. 5 enables recycling of a seat cover 1 made of leather to produce a subsequent product 5 and results in savings in terms of valuable and high-quality leather, and the elimination of complex tanning processes.

FIG. 6 schematically shows another method for producing a seat cover 1 and subsequent panels 4 of a subsequent product 5 composed thereof, wherein the method is characterized in that at least one initial panel 2b is the same size and shape of a subsequent panel 4b of a subsequent product 5 in an initial tailoring step 13. The initial panels 2, at least one of which 2b is the same size and shape as a subsequent panel 4b, are assembled in a seat cover assembly step 14 to form a seat cover 1. After the seat cover 1 is used, it is separated into its initial panels 2 in a separating step 15, wherein at least one initial panel 2b can be used as a subsequent panel 4b to produce a subsequent product 5. The method illustrated in FIG. 6 provides that the subsequent panels 4b are available for producing a subsequent product 5 in a subsequent panel assembly step 17 following the separating step 15, such that an additional subsequent tailoring step 16 is unnecessary. This design of the initial panels 2b has the advantage that a recycling process is significantly more efficient through the elimination of a production step.

As indicated in FIG. 1 and FIG. 6, both of the methods according to the disclosure can be combined as needed for a seat cover 1.

The seat cover according to the disclosure and the methods for producing a seat cover and subsequent panels composed thereof offers the possibility of recycling high-quality leather from seat covers in an efficient manner, and conserving valuable resources.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

### REFERENCE SYMBOLS

1 seat cover
2 initial panel
2a initial panel
2b initial panel
3 joining edge
4 subsequent panel
4a subsequent panel
4b subsequent panel
5 subsequent product
6 leather
7 backing layer
8 outer edge
9 fastening edge
10 recycling section
11 fastening element
12 further initial panel
13 initial tailoring step
14 seat cover assembly step
15 separating step
16 subsequent tailoring step
17 subsequent panel assembly step
18 leather stock

1. A seat cover made of leather for a vehicle seat, comprising:
two or more panels in the form of initial panels, wherein the initial panels are joined at at least one joining edge; and
a subsequent panel of a subsequent product, wherein at least one initial panel is at least as wide as the subsequent panel, and wherein the initial panel is at least as long as the subsequent panel.

2. The seat cover of claim 1, wherein at least one initial panel is the same size and shape of the subsequent panel.

3. The seat cover claim 1, wherein at least one initial panel has the same thickness as the subsequent panel.

4. The seat cover of claim 1, wherein at least one initial panel has the same surface structure on a side facing away from the vehicle seat as a front surface of the subsequent panel.

5. The seat cover of claim 1, wherein at least one initial panel has the same surface structure on a side facing toward the vehicle seat as a back surface of a subsequent panel.

6. The seat cover of claim 1, wherein at least one initial panel has, at least in sections, at least one backing layer on a side of the leather facing toward the vehicle seat.

7. The seat cover of claim 6, wherein at least one backing layer is at least one of a mesh, a knit fabric, a nonwoven, plastic foam, and a batting.

8. The seat cover of claim 6, wherein at least one backing layer is materially bonded to the leather and can be separated therefrom easily, and wherein at least one of an adhesive fabric, a powdered adhesive, a liquid adhesive, a two-component adhesive, and a self-adhesive film is the bonding material.

9. The seat cover of claim 2, further comprising: at least one of another surface structure and another backing layer; and
at least one further initial panel on a surface facing toward the vehicle seat.

10. The seat cover of claim 1, wherein no more than 50% of a surface of the initial panel is provided with a backing layer.

11. The seat cover of claim 1, wherein at least one initial panel does not have a backing layer in a recycling section that is at least as long and wide as the subsequent panel.

12. The seat cover of claim 1, wherein at least one initial panel is joined to at least one further initial panel at at least one joining edge by means of a detachable joining technology.

13. The seat cover of claim 12, wherein at least one initial panel is joined to at least one further initial panel at a joining edge using at least one of ultrasonic welding and a self-dissolving thread.

14. The seat cover of claim 1, wherein the seat cover has at least one fastening element, with which the seat cover can be detachably fastened to the vehicle seat.

15. The seat cover of claim 12, wherein at least one initial panel has at least one fastening element in a fastening edge on a side facing toward the vehicle seat.

16. The seat cover of claim 15, wherein the fastening element is at least one of a mechanical element, a Velcro fastener, an adhesive surface, and a clasp.

17. The seat cover of claim 1, wherein a fastening element on a side of the initial panel facing toward the vehicle seat is joined by means of a detachable joining technology, wherein the fastening element is joined by at least one of ultrasonic welding, a detachable force-fit clamping connection, and/of a detachable adhesive technology.

18. The seat cover of claim 1, wherein the subsequent product is at least one of a shoe, a handbag, a suitcase, a wallet, furniture, and at least part of an article of clothing, which has at least one subsequent panel.

19. A method for producing a seat cover made of leather, comprising:
producing subsequent panels of a subsequent product, the method further comprising:
an initial tailoring step, in which at least one initial panel is at least as wide as a subsequent panel of the subsequent product, and the initial panel is at least as long as the subsequent panel of the subsequent product;
a seat cover assembly step, in which the initial panels are assembled to form the seat cover;
a separating step, in which the seat cover is separated into the initial panels; and
a subsequent tailoring step, in which at least one subsequent panel is cut from at least one initial panel, which can be used for producing the subsequent product.

20. The method for producing the seat cover made of leather of the claim 19, further comprising:
an initial tailoring step, in which at least one initial panel is the same size and shape of the subsequent panel,
a seat cover assembly step, in which the initial panels are assembled to form the seat cover, and
a separating step, in which the seat cover is separated into the initial panels, wherein at least one initial panel can be used as the subsequent panel.
